(19) United States
(12) Patent Application Publication
(10) Pub. No.: US 2009/0163610 A1
(43) Pub. Date: Jun. 25, 2009

(54) CONTINUOUS PROCESS FOR MAKING POLYETHERIMIDE FOAM MATERIALS AND ARTICLES MADE THEREFROM

(76) Inventors: Vincent L. Lanning, Pittsfield, MA (US); Richard D. Lassor, Averill Park, NY (US); Randall Todd Myers, Pittsfield, MA (US); Michael Kane Pilliod, San Francisco, CA (US); Erich Otto Teutsch, Richmond, MA (US)

Correspondence Address: SABIC - 08CT;SABIC Innovative Plastics - IP Legal, ONE PLASTICS AVENUE, PITTSFIELD, MA, 01201-3697, US

(21) Appl. No.: 11/961,328

(22) Filed: Dec. 20, 2007

(51) Int. Cl. C08J 9/04

(52) U.S. Cl. 521/79

(57) ABSTRACT

A continuous process of making polyetherimide foam materials and articles that include these foam materials. The continuous process is a foam extrusion process that uses selected blowing agents, equipment design and processing conditions to continuously produce extruded foam with a substantially uniform cell size in a wide range of cell densities. Subsequent heating may be used in certain embodiments to remove any residual components from the foam, such as any blowing agents or nucleating agents. Due to the greater densities as well as the characteristics inherent in polyetherimide articles, the resulting foam materials are suitable for a much broader range of applications. The continuous process provides a more cost effective product while also avoiding the use of Freon and/or other agents potentially harmful to the environment.

### FIELD OF INVENTION

The present invention relates to polymer foams and, in particular, to continuous methods of making polyetherimide foam materials and articles made from these foam materials.

### BACKGROUND OF INVENTION

Foamed thermoplastic resins and products derived therefrom have achieved a considerable and significant commercial success in a number of fields. These foamed resins have been employed in aircraft and other structures for insulation and structural purposes. The electronics and appliance industry uses polymer foams for electrical and thermal insulation and for structural purposes. In many instances, it is beneficial for the polymer foams to be capable of withstanding higher heat environments. In order to use polymer foam in a high heat environment, a thermoplastic resin capable of withstanding higher heat environments is beneficially used.

One such high heat thermoplastic resin is polyetherimide. Polyetherimide (PEI) foam has been available for a number of years for highly demanding applications where electrical, mechanical and flame performance criteria can justify its application. Justification is difficult due to the high cost of the material and its limited availability. Both are due in part to the batch process employed for its manufacture. The batch process is generally inefficient, is difficult to control, is limited in choices of foam density that can be manufactured and is prone to defects. Nevertheless, foam made using the batch process has demanded a premium price and has been specified for a number of critical DOD applications.

The current “batch” process for PEI foam requires the use of chlorinated solvent and the production of large “buns” of foam that are inconsistent in density and cell structure as well as having defects due to contamination, large voids and un-foamed bits of polymer. The buns are then cut to size in general density ranges of nominal 60, 80 and 110 g/L boards. The inconsistent quality, density and low yield of the batch-formed PEI foams drive the cost of the product too high for most applications. While extrusion processes are used commercially on a large scale for the production of polystyrene, polypropylene, polyethylene and PVC foam board, the process has not previously been successfully applied to producing PEI foam.

Accordingly, it would be beneficial to provide a process for forming a polyetherimide foam that is more efficient than prior art batch processes. It would also be beneficial to provide a process for forming a polyetherimide foam that utilized less resin than prior art processes. Many additional applications in commercial aircraft, high-speed rail and/or marine applications would be feasible if the cost of the PEI foam material could be reduced by a more efficient means of production.

### SUMMARY OF THE INVENTION

The present invention addresses the issues associated with the prior art by providing a polyetherimide (PEI) foam material and a method of making the same that enables the PEI foam to be manufactured more inexpensively and/or with less waste as compared to prior art PEI foams and/or methods. The processes of the present invention utilize one or more blowing agents, nucleating agents and/or CO2 as well as controlling the equipment and processing conditions to produce continuously extruded foam with a substantially uniform cell size in cell densities ranging from 25 to 260 g/L. Due to the greater densities range as well as the characteristics inherent in polyetherimide articles, the resulting foam materials are suitable for a much broader range of applications.

Accordingly, in one aspect, the present invention provides a continuous method for producing a polyetherimide foam including the steps of melting polyetherimide resin in a first extruder; blending at least one blowing agent having a boiling point of 100° C. or less with the melted polyetherimide resin in the extruder under elevated pressure and temperature; feeding the blended mixture to a second extruder; and extruding the polyetherimide foam material from the second extruder through a die under pressure and then fed to a calibrator to form the foam and cool and control thickness, width and further control density of the polyetherimide foam material.

In another aspect, the present invention provides an article that includes a polyetherimide foam material manufactured using a continuous method for producing a polyetherimide foam that includes the steps of melting polyetherimide resin in a first extruder; blending at least one blowing agent having a boiling point of 100° C. or less with the melted polyetherimide resin in the extruder under elevated pressure and temperature; feeding the blended mixture to a second extruder; feeding the mixture into a die under pressure and then feeding to a calibrator for forming the polyetherimide foam material.

### BRIEF DESCRIPTION OF THE DRAWINGS

FIGS. 1 and 2 show the Log Differential Intrusion vs. Pore size for two foam materials made according to the continuous processes of the present invention.

FIGS. 3 and 4 show the Log Differential Intrusion vs. Pore size for two foam materials made according to the batch processes of the prior art.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the singular form “a,” “an,” and “the” may include plural referents unless the context clearly dictates otherwise. Also, as used in the specification and in the claims, the term “comprising” may include the embodiments “consisting of” and “consisting essentially of.” Furthermore, all ranges disclosed herein are inclusive of the endpoints and are independently combinable.

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

The present invention provides a foam extrusion process for forming a polyetherimide (PEI) foam material, such as a PEI foam board. By combining selected blowing agents, equipment design and processing conditions it is possible to produce continuously extruded foam with a substantially uniform cell size in a wide range of densities (e.g. from 25 to 260 g/L) and dimensions and, under some conditions, with no residual nucleating agent. These foams are therefore suitable for a much broader range of applications and due to the high efficiency of the process even provide a more cost effective product for use in less critical applications. The current, commercially available density range for PEI foam is nominally 60 to 110 g/L.

Accordingly, in one aspect, the present invention provides a process for manufacturing a foam material that includes the use of an organic polymer. In one embodiment, polyimides may be used as the organic polymers in the foam materials. Useful thermoplastic polyimides have the general formula (I)

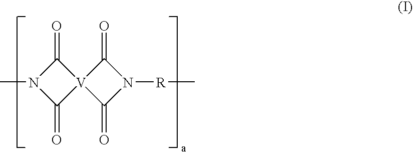

wherein a is greater than or equal to 10, and, in an alternative embodiment, greater than or equal to 1000; and wherein V is a tetravalent linker without limitation, provided the linker does not impede synthesis or use of the polyimide. Suitable linkers include, but are not limited to, (a) substituted or unsubstituted, saturated, unsaturated or aromatic monocyclic and polycyclic groups having 5 to 50 carbon atoms, (b) substituted or unsubstituted, linear or branched, saturated or unsaturated alkyl groups having 1 to 30 carbon atoms; or combinations thereof. Suitable substitutions and/or linkers include, but are not limited to, ethers, epoxides, amides, esters, and combinations thereof. Beneficial linkers include, but are not limited to, tetravalent aromatic radicals of formula (II), such as

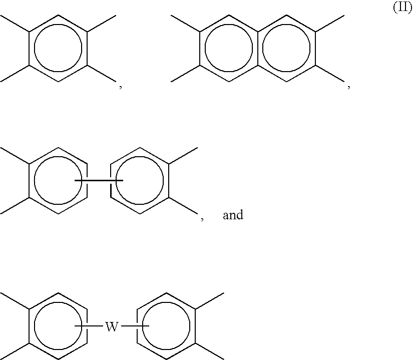

wherein W is a divalent moiety selected from —O—, —S—, —C(O)—, —SO₂—, —SO—, —C_{y}H_{2y}— (y being an integer from 1 to 5), and halogenated derivatives thereof, including perfluoroalkylene groups, or a group of the formula —O-Z-O— wherein the divalent bonds of the —O— or the —O-Z—O— group are in the 3,3′, 3,4′, 4,3′, or the 4,4′ positions, and wherein Z includes, but is not limited, to divalent radicals of formula (III).

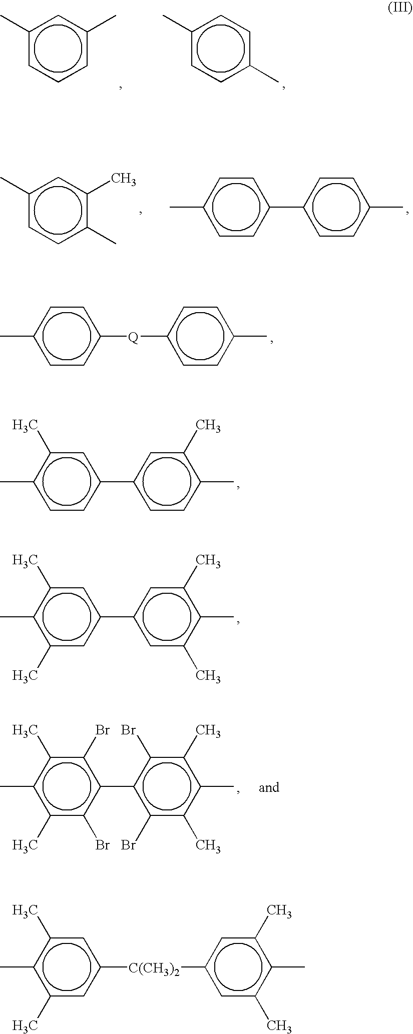

R in formula (I) includes substituted or unsubstituted divalent organic radicals such as (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, or (d) divalent radicals of the general formula (IV)

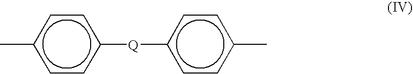

wherein Q includes a divalent moiety selected from —O—, —S—, —C(O)—, —SO₂—, —SO—, —C_{y}H_{2y}— (y being an integer from 1 to 5), and halogenated derivatives thereof, including perfluoroalkylene groups.

In alternative embodiments, the classes of polyimides that may be used in the foam materials include polyamidimides and polyetherimides, particularly those polyetherimides that are melt processable.

In alternative embodiments of the present invention, polyetherimide polymers including more than 1 structural unit of the formula (V) are used. In an alternative embodiment, polyetherimide polymers including 10 to 1000 structural units of the formula (V) are used. In still other alternative embodiments, polyetherimide polymers including 10 to 500 structural units of the formula (V) are used.

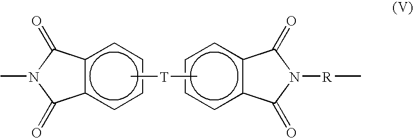

wherein T is —O— or a group of the formula —O-Z-O— wherein the divalent bonds of the —O— or the —O-Z-O— group are in the 3,3′, 3,4′, 4,3′, or the 4,4′ positions, and wherein Z includes, but is not limited, to divalent radicals of formula (III) as defined above.

In one embodiment, the polyetherimide may be a copolymer, which, in addition to the etherimide units described above, further contains polyimide structural units of the formula (VI)

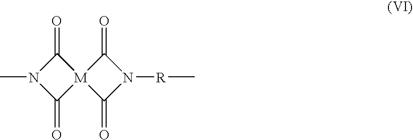

wherein R is as previously defined for formula (I) and M includes, but is not limited to, radicals of formula (VII).

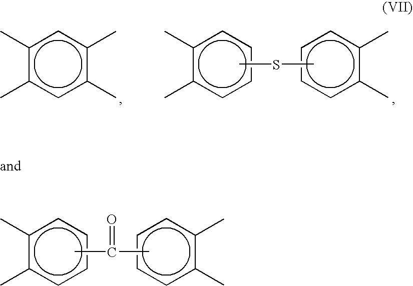

The polyetherimide can be prepared by any of the methods including the reaction of an aromatic bis(ether anhydride) of the formula (VIII)

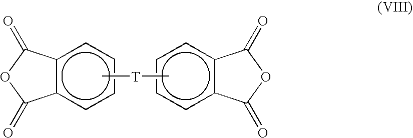

with an organic diamine of the formula (IX)

H₂N—R—NH₂ (IX)

wherein T and R are defined as described above in formulas (I) and (IV).

Illustrative examples of aromatic bis(ether anhydride)s of formula (VIII) include 2,2-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride and 4-(2,3-dicarboxyphenoxy)-4′-(3,4-dicarboxyphenoxy)diphenyl sulfone dianhydride, as well as various mixtures thereof.

The bis(ether anhydride)s may be prepared by the hydrolysis, followed by dehydration, of the reaction product of a nitro substituted phenyl dinitrile with a metal salt of dihydric phenol compound in the presence of a dipolar, aprotic solvent. A beneficial class of aromatic bis(ether anhydride)s included by formula (VIII) above includes, but is not limited to, compounds wherein T is of the formula (X)

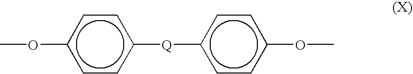

and the ether linkages, for example, are beneficially in the 3,3′, 3,4′, 4,3′, or 4,4′ positions, and mixtures thereof, and where Q is as defined above.

Any diamino compound may be employed in the preparation of the polyimides and/or polyetherimides. Examples of suitable compounds are ethylenediamine, propylenediamine, trimethylenediamine, diethylenetriamine, triethylenetertramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy) ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl)methane, bis(2-chloro-4-amino-3,5-diethylphenyl) methane, bis(4-aminophenyl)propane, 2,4-bis(b-amino-t-butyl) toluene, bis(p-b-amino-t-butylphenyl)ether, bis(p-b-methyl-o-aminophenyl) benzene, bis(p-b-methyl-o-aminopentyl)benzene, 1,3-diamino-4-isopropylbenzene, bis(4-aminophenyl)sulfide, bis(4-aminophenyl)sulfone, bis(4-aminophenyl) ether and 1,3-bis(3-aminopropyl)tetramethyldisiloxane. Mixtures of these compounds may also be present. In one embodiment, the diamino compounds are aromatic diamines, especially m- and p-phenylenediamine and mixtures thereof.

In an exemplary embodiment, the polyetherimide resin includes structural units according to formula (V) wherein each R is independently p-phenylene or m-phenylene or a mixture thereof and T is a divalent radical of the formula (XI)

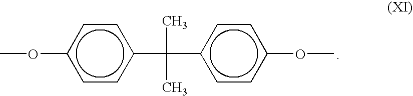

In general, the reactions can be carried out employing solvents such as o-dichlorobenzene, m-cresol/toluene, or the like, to effect a reaction between the anhydride of formula (VIII) and the diamine of formula (IX), at temperatures of 100° C. to 250° C. Alternatively, the polyetherimide may be prepared by melt polymerization of aromatic bis(ether anhydride)s of formula (VIII) and diamines of formula (IX) by heating a mixture of the starting materials to elevated temperatures with concurrent stirring. Generally, melt polymerizations employ temperatures of 200° C. to 400° C. Chain stoppers and branching agents may also be employed in the reaction. When polyetherimide/polyimide copolymers are employed, a dianhydride, such as pyromellitic anhydride, is used in combination with the bis(ether anhydride). The polyetherimide polymers can optionally be prepared from reaction of an aromatic bis(ether anhydride) with an organic diamine in which the diamine is present in the reaction mixture at no more than 0.2 molar excess, and beneficially less than 0.2 molar excess. Under such conditions the polyetherimide resin has less than 15 microequivalents per gram (μeq/g) acid titratable groups, and beneficially less than 10 μeq/g acid titratable groups, as shown by titration with chloroform solution with a solution of 33 weight percent (wt %) hydrobromic acid in glacial acetic acid. Acid-titratable groups are essentially due to amine end-groups in the polyetherimide resin.

Generally, useful polyetherimides have a melt index of 0.1 to 10 grams per minute (g/min), as measured by American Society for Testing Materials (ASTM) D1238 at 295° C., using a 6.6 kilogram (kg) weight. In a select embodiment, the polyetherimide resin has a weight average molecular weight (Mw) of 10,000 to 150,000 grams per mole (g/mole), as measured by gel permeation chromatography, using a polystyrene standard. Such polyetherimide polymers typically have an intrinsic viscosity greater than 0.2 deciliters per gram (dl/g), beneficially 0.35 to 0.7 dl/g measured in m-cresol at 25° C.

In addition to the organic polymer resin, the methods of the present invention also utilize one or more blowing agents in the continuous process for use in forming the foams. While the finished foam product is substantially free of the blowing agents, it is contemplated that residual amounts of the one or more blowing agents may remain in the foam material, although these residual amounts are not sufficient to adversely affect the foam characteristics of the foam material.

Accordingly, in one embodiment, the process of forming the polymeric foams uses one or more blowing agents in the continuous process. In one embodiment, the blowing agent or agents are selected from blowing agents having a low boiling point. As used herein, a “low boiling point” blowing agent is beneficially one having, in one embodiment, a boiling point of less than 100° C. In another embodiment, a “low boiling point” blowing agent is one having a boiling point of less than 90° C. In still another embodiment, a “low boiling point” blowing agent is one having a boiling point from 50° C. to 85° C. However, there are select embodiments wherein a “low boiling point” blowing agent includes water, carbon dioxide, nitrogen or argon. As such, in these embodiments, the boiling point may be greater or much lower than 100° C.

Examples of blowing agents that may be used in the present invention include, but are not limited to, low boiling ketones such as acetone, alcohols such as methanol, cyclohexane, esters such as ethyl acetate, or mixtures including at least one of the foregoing blowing agents. In alternative embodiments, carbon dioxide, nitrogen gas, argon and/or even water may be used. In general, any agent capable of being injected and blended into a melt to continuously produce a PEI foam material may be used. Chlorinated hydrocarbons and ethers or di-ethers may be used in alternative embodiments if toxicity and formation of peroxides for ethers or their ignition on contacting hot melt or equipment surfaces are not considered a problem. However, in beneficial embodiments, no Freon or related blowing agents are used for environmental reasons. And as the continuous process of the present invention is capable of forming PEI foam materials with non-Freon blowing agents, these embodiments are preferred. Ethers may be used in still other alternative embodiments, though it is beneficial in these embodiments to prevent the ethers from forming peroxides and/or preventing their ignition as soon as they exit the die and mix with the air.

The blowing agents are selected such that they have some solubility in PEI. As discussed, it is contemplated that there may be some residual blowing agent that will remain in the PEI foam for an extended time after extrusion, although the high extrusion temperatures used to form the foam help to drive off most of the blowing agent as the melt exits the die. In alternative embodiments, any of the residual blowing agent level may be reduced by exposing the foam material to a heat cycle.

The continuous process also uses a sufficient amount of the blowing agent and the blowing agent is selected to be sufficiently soluble to grow the voids into the bubbles that form the foam. As a result, if all of the parameters including solubility of the blowing agent with the PEI melt (at pressure, temperature and shear rate) are balanced and the walls of the bubbles are sufficiently stable such that they do not rupture or coalesce until the viscosity/melt strength of the resin/blowing agent is strong enough to form a stable foam as it cools, the result is a good, uniform, small celled foam.

As such, in beneficial embodiments, a blowing agent is selected such that it is a solvent that is substantially soluble in the polymer only under high heat and pressure, but that defuses and evaporates from the polymer at a selected rate to provide plasticization until the polymer cools and the foam is stable.

As a result, the type of blowing agent or agents used will vary depending on the final characteristics of the polymeric foam to be formed. For example, it has been determined that, for lower density foams, certain blowing agents are more useful than others. Conversely, for higher density foams, other blowing agents are more useful. Regardless, the amount of blowing agent or agents used is, in one embodiment, from 1 to 15 percent by weight of the total weight of the PEI. In an alternative embodiment, the amount of blowing agent or agents used is, in one embodiment, from 3 to 10 percent by weight of the total weight of the PEI. The exact amount of blowing agent or agents used will depend on one or more factors including, but not limited to, the selected density of the foam product, the process parameters and/or which blowing agent or mixture of agents is used.

For lower density foams, it is beneficial to select a blowing agent that has a lower boiling point and/or blowing agents that have a substantially lower solubility in the PEI melt in the extruder. These lower boiling point blowing agents beneficially maintain a very high pressure in the extruder die such that they suppress expansion of the PEI melt in the die before exiting the die. The foaming itself cools the resin due to the loss of the blowing agent to the atmosphere.

For higher density foams, it is beneficial to select a blowing agent that has a higher boiling point and/or blowing agents that have a higher solubility in the PEI melt in the extruder. These higher boiling point blowing agents do not expand the PEI melt as much as the melt temperature starts to drop. As a result, when the foaming begins, it does so with a less-expanded material such that when the foam material cools due to loss of the blowing agent to the atmosphere, a higher density foam is formed.

Therefore, by varying the type of blowing agent used, the continuous process of the present invention may be used to form PEI foam materials in a wide range of densities, such as from 25 to 300 g/L, which includes the densities of the prior art foam materials made by batch processes as well as permitting lower density and/or higher density foam materials to be manufactured.

In addition to the blowing agent, though, the type of foam to be produced may also vary depending on other factors such as the presence of nucleating agent particles, the loading and/or process conditions, and the type of equipment used to form the foam materials. The nucleating agent helps control the foam structure by providing a site for bubble formation, and the greater the number of sights, the greater the number of bubbles and the less dense the final product will be. As such, for lower density foams, a larger amount of nucleating agent may be used while no or very small amounts of nucleating agent may be used for embodiments where higher density foams are manufactured.

Accordingly, in those embodiments wherein a lower-density foam material is to be produced, the methods of the present invention include the use of a nucleating agent. Nucleating agents that may be used in the present invention include, but are not limited to, metallic oxides such as titanium dioxide, clays, talc, silicates, silica, aluminates, barites, titanates, borates, nitrides and even some finely divided, unreactive metals, carbon-based materials (such as diamonds, carbon black and even nanotubes) or combinations including at least one of the foregoing agents. In alternative embodiments, silicon and any crosslinked organic material that is rigid and insoluble at the processing temperature may also function as nucleating agents.

In alternative embodiments, other fillers may be used provided they have the same effect as a nucleating agent in terms of providing a site for bubble formation. This includes fibrous fillers such as aramid fibers, carbon fibers, glass fibers, mineral fibers, or combinations including at least one of the foregoing fibers.

When used, in one embodiment, the amount of nucleating agent used is from 0.1 to 5 percent by weight of the total weight of the PEI. In another embodiment, the amount of nucleating agent used is from 0.2 to 3 percent by weight of the total weight of the PEI. In still another embodiment, the amount of nucleating agent used is from 0.5 to 1 percent by weight of the total weight of the PEI.

In addition to the amount, the type of nucleating agent can be used to help control the density of the foam. Certain nucleating agents have different amounts of nucleating sites that can be formed and, therefore help control the size of the bubbles formed thereon. Usually the larger the bubbles formed, the less dense the foam material and the smaller the bubbles formed, the more dense the foam material. In general, all other factors being equal nucleating agents having few nucleating sites result in larger bubbles and a less dense foam material. Conversely, nucleating agents having many nucleating sites result in smaller bubbles and a more dense foam material. In those embodiments that do not use a nucleating agent, a columnar bubble structure develops that exhibits high compressive strength. In general, the density of the foam is due to the fraction of empty volume per unit volume, which can be controlled by the size of the bubbles and/or the wall thickness of the bubbles.

In addition, controlling the process parameters may be used to help form a PEI foam material having a selected density. By operating the process at lower throughputs and longer residence times, the combination of the blowing agent, a nucleating agent and the longer residence times in the calibrator results in a less dense product. Not wishing to be bound by theory, it is believed that the lower throughput and higher residence times in the calibrator enables the foam formation in the calibrator to continue longer thereby resulting in a less dense final form material. Conversely, higher throughput and/or shorter residence times in the calibrator may be used to form higher density foam materials. In addition, pressure and/or temperature control may be used to help increase or decrease the rate of foam formation, thereby helping to control the density of the manufactured foam material.

In those embodiments wherein a dense foam material is formed, low levels of supercritical CO₂ may be used in lieu of the nucleating agent used for lower density foams. When used, in one embodiment, the amount of CO₂ used is from 0.01 to 5 percent by weight of the total weight of the PEI. In another embodiment, the amount of CO₂ used is from 0.1 to 1 percent by weight of the total weight of the PEI. In still another embodiment, the amount of CO₂ used is from 0.2 to 0.4 percent by weight of the total weight of the PEI.

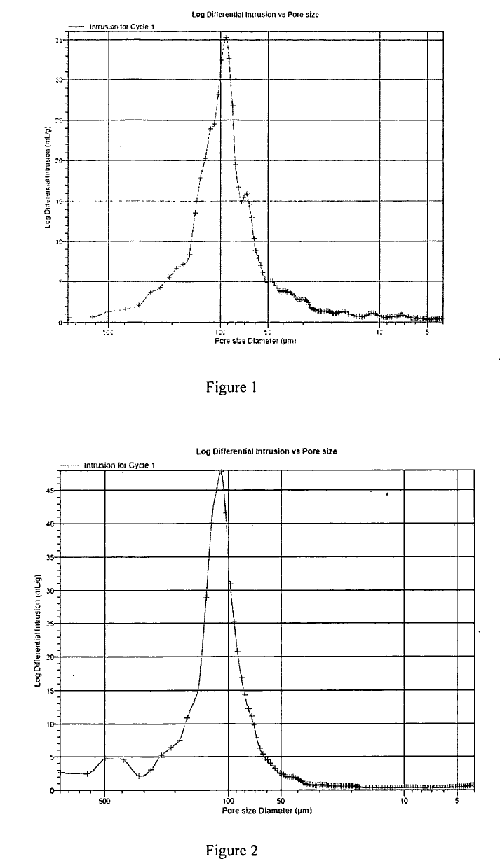

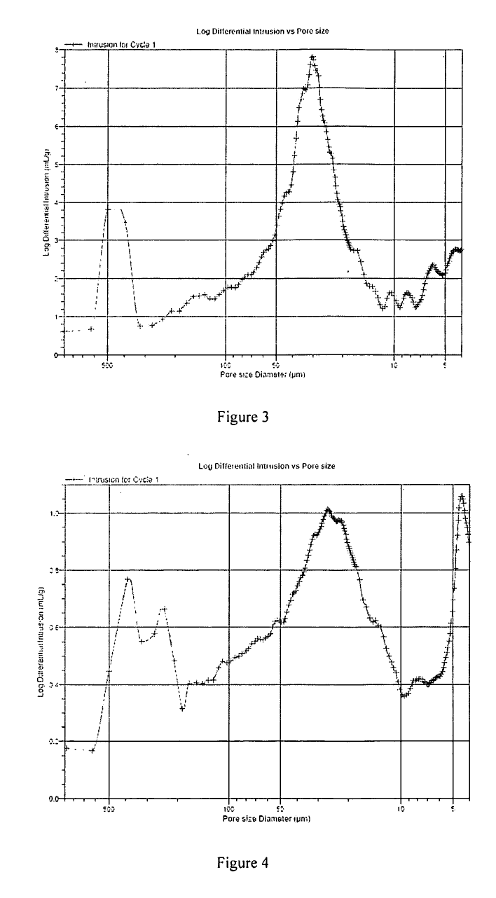

The process of the present invention is capable of forming a foam material that has a substantially uniform cell size. As used herein, a “substantially uniform cell size” refers to a foam material wherein at least 50% of the pores are within ±20 microns of a single pore size selected on the basis of the density of the foam material. As a result, a Log Differential Intrusion vs. Pore Size graph of the foam material would reflect a unimodal distribution. In addition, the Log Differential Intrusion (in mL/g) is higher (i.e. greater than 10) as compared to batch processes. In another embodiment, a “substantially uniform cell size” refers to a foam material wherein at least 70% of the pores are within ±20 microns of a single pore size selected on the basis of the density of the foam material. In addition, the Log Differential Intrusion (in mL/g) is greater than 20. The advantage to a uniform cell size is better mechanical properties since larger cells act as a weak point in the foam, which may initiate a failure. As can be seen in FIGS. 1-4, the foam materials made according to the present invention (FIGS. 1 and 2) have a single “spike” in the distribution of cell size while foam materials made according to prior art methods (FIGS. 3 and 4) do not.

The processes of the present invention are capable of forming a wide range of densities of PEI foam materials in a continuous manner. In one embodiment, the PEI foam materials are formed using an extrusion process. In this process, the PEI resin and any nucleating agent are first melt blended together in a primary extruder. The blowing agent is then fed into the primary extruder and mixed into the melt blend under high pressure and temperature in the last sections of the primary extruder. The melt is then fed under pressure to a secondary extruder, which is used to cool the foam material and transport the polyetherimide foam material through a die to a calibrator to form the foam material. The calibrator helps to control the cooling rate of the foam material and, therefore, enables control over the thickness, width and density of the foam material. The die is operated at a specific temperature range and pressure range to provide the necessary melt strength and to suppress premature foaming in the die. In one embodiment, a single screw extruder is used for both the primary extruder and the secondary extruder. In an alternative embodiment, a twin-screw extruder is used for both the primary extruder and the secondary extruder. In yet another alternative embodiment, a single screw extruder is used for one of the primary extruder or the secondary extruder and a twin-screw extruder is used for the other.

As discussed, the processes of the present invention enable polymeric foams to be formed in a wide range of cell densities, from 25 g/L to 260 g/L or even higher. This wider range is available due to one or more factors including, but not limited to, the number and/or types of blowing agents used, the number and/or types of nucleating agents used, the type and/or design of the equipment used in the process, the use of a continuous process to form the polymeric foam, and/or the processing conditions.

Therefore, as a result of having a wide range of cell densities that can be manufactured, the resulting polymeric foam may be used in a larger number of applications heretofore unavailable to polymeric foam due to cost and/or characteristics of the foam. The lower density foam exhibits sufficient mechanical properties to be considered as a substitute for “crush core” applications, where its low density and ease of lamination outperform the current, thermoset “honeycomb” material. The higher density foam offers excellent mechanical properties with capability of being thermoformable. Pure PEI resin generally contains no ionic materials and, as a result, offers excellent dielectric properties and radar transparency. Foamed PEI resin provides substantially similar thermal properties, but at low density compared to unfoamed PEI resin, making the foamed PEI resin especially useful for “raydome” or radar cover applications.

The PEI foam materials, as formed may be in a variety of shapes, such as foam boards, foam tubes or any shape of foam material capable of being formed in a calibrator.

All cited patents, patent applications, and other references are incorporated herein by reference in their entirety. The invention is further illustrated by the following non-limiting examples.

### EXAMPLES

Several polyetherimide foam materials were made. In these samples, PEI resin (ULTEM™ 1000 PEI resin pellets available from SABIC Innovative Plastics) were melt-blended in a Berstorff Schaumex® twin-screw extruder with varying levels of talc (Microtuff AG 609), acetone, methanol and/or carbon dioxide, depending on whether a less dense foam or a more dense foam was to be formed. The melt was then fed under pressure to a second Berstorff twin-screw extruder, which was used to cool the melt blend. From there, the melt blend was transported through a die to a calibrator where foaming of the product occurred to form the final foam material.

Table 1 shows the compositional make-up for three examples of PEI foam made according to the concepts of the present invention. Table 2 provides the processing parameters for each sample as well as the resulting physical characteristics of each material. As may be seen, the processes of the present invention were able to form a PEI foam having a high melt temperature while forming both high density and low density foams, and at densities heretofore unable to be produced using conventional batch processes.

As seen in the examples, lower density foam materials can be formed using process parameters that result in lower amounts of material being formed but being processed for longer periods of time. As such, the use of lower amounts of materials and longer processing times helps to form a foam material that has a much lower density. Conversely, processing more material in a shorter period of time results in a foam material having a higher density, despite being formed at the same temperature as the lower density foam materials. The densities can also be selected based on the blowing agents used, as seen between samples 1 and 2.

TABLE 1

| Composition: | Sample 1 | Sample 2 | Sample 3 |
|---|---|---|---|
| ULTEM ™ 1000 PEI resin pellets | 100 parts | 100 parts | 100 parts |
| Talc (Microtuff AG 609, densified) | 1.0 parts | 0.5 parts | 0.0 parts |
| Acetone | 8.0 parts | 4.8 parts | 6.0 parts |
| Methanol | | 1.2 parts | 0.0 parts |
| CO₂ | | | 0.29 parts |

TABLE 2

| | Feed Rate | Screw Speed | Melt Temp. | Screw Speed | Melt Temp. | Melt Press. | Density |
|---|---|---|---|---|---|---|---|
| Sample | Kg/hr | (Primary) rpm | ° C. | (Cooling) rpm | ° C. | Bar | g/L |
| 1 | 50 | 90 | 380 | 7 | 226 | 64 | 27 |
| 2 | 50 | 100 | 380 | 5 | 228 | 87 | 44 |
| 3 | 100 | 290 | 380 | 8 | 237 | 110 | 230 |

In regards to the prior art batch processes, and as discussed previously, the continuous process of the present invention also produces foam materials having a substantially uniform cell size. This may be seen in FIGS. 1-4. As can be seen in FIG. 1 (60 kg/m³ density foam material) and FIG. 2 (80 kg/m³ density foam material), the Log Differential Intrusion vs. Pore Size charts of these two materials show a unimodal distribution, with the Log Differential Intrusion (mL/g) near 35 at a pore size of app. 90 for the 60 kg/m³ density foam material and a Log Differential Intrusion (mL/g) near 48 at a pore size of app. 110 for the 80 kg/m³ density foam material.

Conversely, as may be seen in FIGS. 3 and 4, a batch process for making a 60 kg/m³ density foam material (FIG. 3) and a batch process for making a 80 kg/m³ density foam material (FIG. 4) result in much lower Log Differential Intrusions (less than 10) with multiple peaks in the distribution along pore size, such that there is a bi-modal or even multi-modal distribution of cell sizes in these foam materials.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A method for continuously forming a polyetherimide foam material comprising the steps of:
melting polyetherimide resin in a first extruder;
blending at least one blowing agent having a boiling point of 100° C. or less with the melted polyetherimide resin in the extruder under elevated pressure and temperature;
feeding the blended mixture to a second extruder;
feeding the blended mixture to a die under pressure; and
feeding the blended mixture to a calibrator for forming the polyetherimide foam material and to cool and control thickness, width and further control density of the polyetherimide foam material.

2. The method of claim 1, further comprising the step of mixing a nucleating agent with the polyetherimide resin prior to addition of the at least one blowing agent.

3. The method of claim 2, wherein the nucleating agent is selected from talc, a clay, or a combination including at least one of the foregoing nucleating agents.

4. The method of claim 3, wherein the nucleating agent is added in an amount of from 0.1 to 5 percent by weight of the total weight of the polyetherimide resin.

5. The method of claim 2, further comprising the step of heating the polymeric foam material to remove any residual blowing agent or gaseous nucleating agent from the polyetherimide foam material.

6. The method of claim 1, further comprising the step of mixing supercritical CO₂ with the polyetherimide resin prior to addition of the at least one blowing agent.

7. The method of claim 6, wherein the supercritical CO₂ is added in an amount of from 0.01 to 2 percent by weight of the total weight of the polyetherimide resin.

8. The method of claim 6, further comprising the step of heating the polymeric foam material to remove any residual blowing agent or supercritical CO₂ from the polyetherimide foam material.

9. The method of claim 1, wherein the at least one blowing agent is selected from a ketone, an alcohol, cyclohexane, an ester, or mixtures including at least one of the foregoing blowing agents.

10. The method of claim 1, wherein the at least one blowing agent is added in an amount from 1 to 15 percent by weight of the total weight of the polyetherimide resin.

11. The method of claim 1, wherein the first extruder is a twin-screw extruder.

12. The method of claim 1, wherein the polymeric foam material has a substantially uniform cell size.

13. A polyetherimide foam material having a density of 25 g/L to 260 g/L as made by the method of claim 1.

14. An article of manufacture comprising the polyetherimide foam material of claim 13.
